(19) United States
(12) Patent Application Publication
(10) Pub. No.: US 2019/0137091 A1
(43) Pub. Date: May 9, 2019

(54) FABRIC PANEL ILLUMINATED WITH OPTICAL FIBER

(71) Applicant: RUBELLI S.P.A., Venezia (IT)

(72) Inventors: Andrea FAVERETTO RUBELLI, VENEZIA (IT); Giorgio MEDA, VENEZIA (IT); Livio PINI, VENEZIA (IT)

(21) Appl. No.: 16/183,010

(22) Filed: Nov. 7, 2018

(30) Foreign Application Priority Data
Nov. 8, 2017 (IT) 102017000127320

(51) Int. Cl. F21V 33/00; F21V 8/00

(52) U.S. Cl. CPC F21V 33/0028; F21W 2121/00; G02B 6/0005

(57) ABSTRACT

A fabric panel illuminated with optical fiber comprising a perimeter frame, a covering fabric applied frontally to the perimeter frame and covering the latter, said covering fabric comprising, in weft and/or warp, a plurality of optical fibers interwoven with textile fibers, lighting means electrically connected to power supply means and operatively connected to said optical fibers so as to convey beams of light therein. Advantageously, the perimeter frame comprises a first support element, whereon the lighting means are fixed, and a second support element, interposed between the covering fabric and the first support element, whereon the covering fabric is fixed.

### SCOPE

The present invention concerns a fabric panel illuminated with optical fiber.

### STATE OF THE ART

As is well known, in the art there exist fabric panels equipped with lighting means, also of the LED type.

Such panels are real furnishing elements often used to cover walls and ceilings in interiors.

The panel is typically made up of a frame on which a fabric covering with any decorative motif is applied. The lighting may be placed on the rear of the panel in such a way that it is not directly visible and thus produces a diffused light effect.

The rear positioning of the lighting means, i.e. on the back, also facilitates the installation of the corresponding power supply devices, which can therefore be concealed from the sight of an outside observer.

The use of fabrics comprising, on the weft and/or warp, optical fibers interwoven with natural or synthetic fibers of various colors is also known. The optical fibers are operatively connected to one or more light sources, typically LED, so as to receive a beam of light from the latter and to diffuse it, by subsequent internal reflections, along the fibers themselves.

In this way, the light is extracted from the inside of the fibers of the fabric, unlike the more classic solutions wherein the light is placed behind the panel.

The solutions that provide optical fibers interwoven with the threads of weft and/or warp allow different and particularly sought-after lighting effects to be obtained.

Fiber-optic solutions obviously present higher technical difficulties.

First of all, the optical fibers are delicate to bend and/or weave, and they must also be properly connected to the lighting sources in order to receive from the latter the light beams to be transmitted.

Such connections must obviously be concealed from an outside observer.

Moreover, LED lighting devices, particularly suitable to be coupled to the optical fibers, even if they have a high luminous efficiency, require a good thermal dispersion.

Therefore, the means of powering these types of panels must be effectively cooled to avoid the risk of damaging the fabric applied to them, especially when using particularly fine and delicate fabrics.

Moreover, in the interior design sector, there is often the need to modify the fabrics applied to the frames of the various panels. It is therefore necessary to create a panel architecture that allows one to remove and then re-apply the fabric to the frame of the relevant panel quickly and without damaging the fabric. This operation must be easy and fast and must not in any way involve the risk of damaging the fabric, which is the most delicate element of the panel.

### PRESENTATION OF THE INVENTION

The need is therefore perceived to resolve the drawbacks and limitations cited with reference to the known art.

Therefore, the need is felt to create a panel that may effectively disperse the heat generated by the lighting means and that allows an easy and quick removal and subsequent reassembly of the front panel without the risk of damaging the fabric in any way.

Such requirement is met by a fabric panel illuminated with optical fiber according to claim 1.

### DESCRIPTION OF THE DRAWINGS

Further features and advantages of the present invention will become more apparent from the following description of the preferred and non-limiting examples of embodiment thereof, wherein:

FIG. 1 shows a front view of a fabric panel according to the present invention;

FIG. 2 shows a view of the fabric panel in FIG. 1, without the covering fabric;

FIG. 3 shows a plan view of the panel of FIG. 1;

FIG. 4 shows a rear view of the panel of FIG. 1;

FIG. 5 shows the enlarged detail V shown in FIG. 4;

FIG. 6 shows a sectional view of the panel of FIG. 1, along the sectional plane VI-VI indicated in FIG. 1.

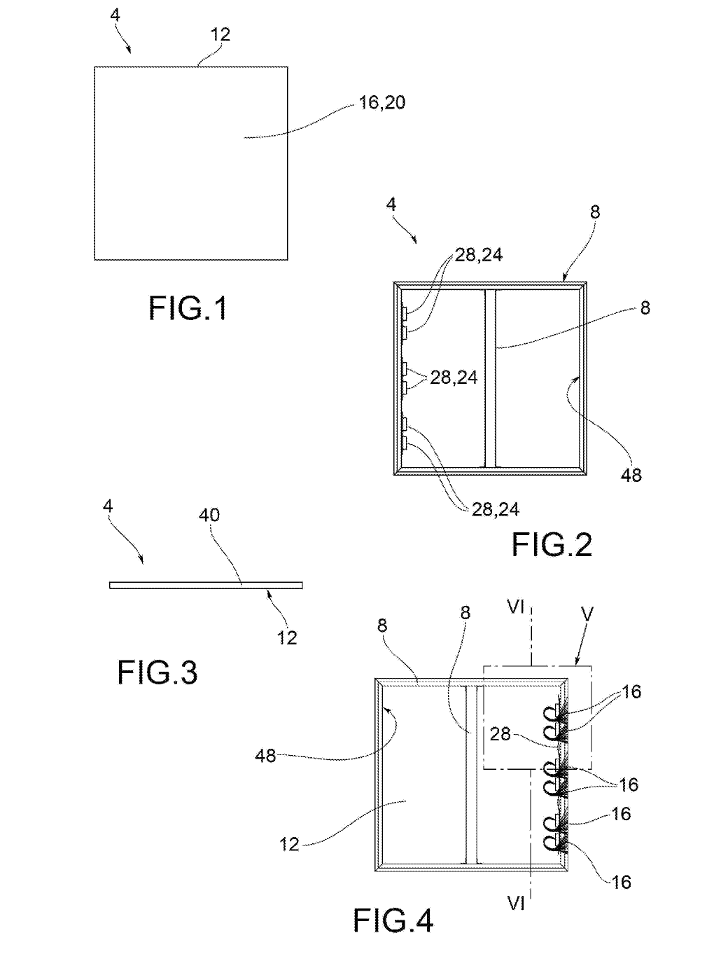

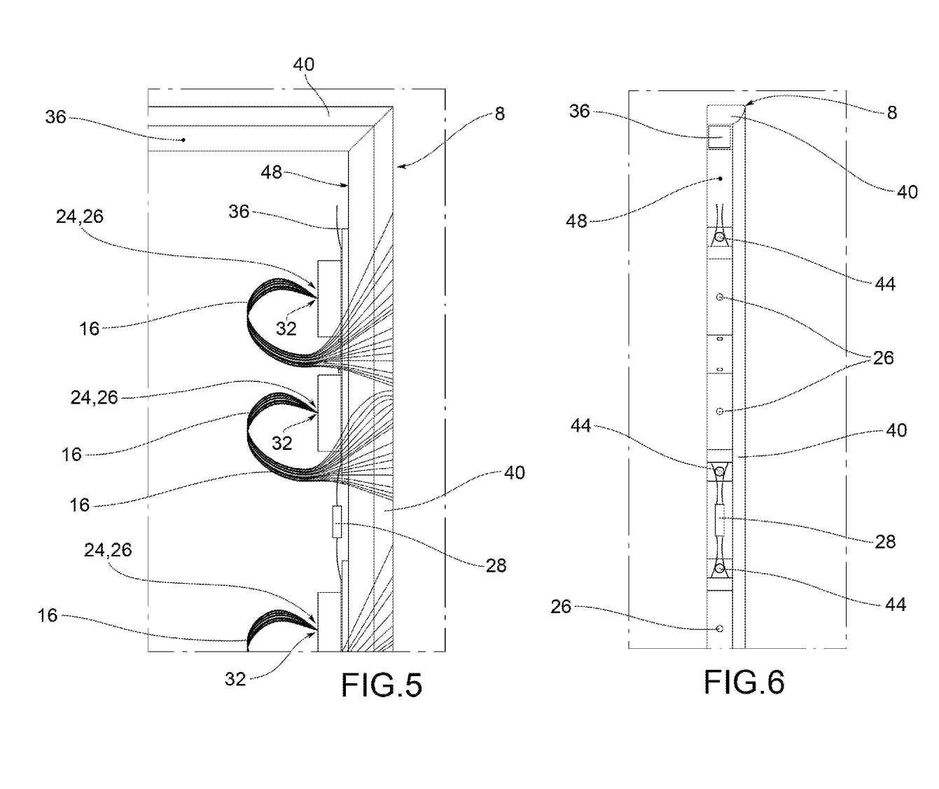

The elements or parts of elements in common between the embodiments described hereinafter will be indicated at the same numerical references.

### DETAILED DESCRIPTION

With reference to the aforesaid figures, a schematic overall view of a fabric panel illuminated with optical fiber according to the present invention is collectively indicated at 4.

It should be noted that, for the purposes of protecting the present invention, the dimensions and type of the panel are not indicated; moreover, within certain limits specified below, the type of fabric used is not indicated.

The panel 4 comprises a perimeter frame 8, preferably shaped to form a closed polyline.

A covering fabric 12 is applied frontally to the perimeter frame 8 and covers the latter.

For the purposes of this invention, the covering fabric 12 may be of any color; it may comprise decorative motifs or even be monochromatic.

The covering fabric 12 is made up of a plurality of optical fibers 16 in weft and/or warp interwoven with textile fibers 20 of various kinds.

The optical fibers 16 are shaped to allow the transmission of light beams for total internal reflection (TIR). Preferably, said optical fibers 16 comprise extractor elements (not shown and of a known type) that allow light beams to be extracted through the external side walls thereof so as to emit light at the weft and/or warp of the covering fabric 12.

In this way, a backlit fabric is not obtained (as in the solutions of the known art) but rather a fabric wherein the light comes from inside the interwoven fibers.

The textile fibers 20 may be natural fibers and/or synthetic fibers.

The panel 4 further comprises lighting means 24 electrically connected to power supply means 28 and operatively connected to said optical fibers 16 so as to convey beams of light therein.

Preferably, the light sources 24 comprise light-emitting diodes 26 (LEDs).

Light-emitting diodes 26 typically comprise a bulb from which light beams are emitted, which are directly channeled into the input ends 32 of optical fibers 16 and then channeled therefrom toward opposite output ends and extracted, as seen, by the extractor elements.

Advantageously, the perimeter frame 8 comprises a first support element 36, whereon the lighting means 24 are fixed, and a second support element 40, interposed between the covering fabric 12 and the first support element 36, whereon the covering fabric 12 is fixed.

The first support element 36 is preferably a metal element whereon the power supply means 28 of the lighting means 24 are fixed; the metal element not only performs a structural function but also a function of thermal dispersion.

For example, the first support element 36 is an aluminum element.

Preferably, power supply means 28 and/or lighting means are removably fixed to the first support element 36 by means of removable connection means 44.

For example, removable connection means 44 comprise screws and/or bolts.

Preferably, the power supply means 28 and/or lighting means 24 are fixed to an inner side wall 48 of the first support element 36.

In this way, the space delimited internally by the first support element 36 is exploited.

According to one embodiment, the second support element 40 is a thermally and electrically insulating element that separates the covering fabric 12 from the first support element 36.

For example, the second support element 40 is made of wood and/or plastic.

Preferably, the second support element 40 is contoured to the first support element 36 in order to follow its perimeter profile.

The second support element 40, as seen, essentially acts as a spacer between the covering fabric 12 and the first support element 36; this prevents direct contact between the covering fabric 12 and the first support element 36. Thus, heating and the consequent damage to the covering fabric 12 is avoided by the first support element 36, which acts as a heat sink for the heat generated by the lighting means 24, as well as the power supply means 28, as well as a fixing element for both the lighting means 24 and the power supply means 28.

The optical fibers 16 of the covering fabric 12 are grouped in bundles, each bundle being turned back at the rear of the panel 4, on the opposite side to the covering fabric 12, and fixed to a corresponding lighting means 24 on the first support element 36.

According to a preferred embodiment, on said first support element 36 are fixed a plurality of lighting means 24 electrically connected in series with each other and powered by a single power supply means 28.

According to a further possible embodiment, a layer of blackout fabric (not shown) is also installed between the perimeter frame 8 and the covering fabric 12 to prevent the light emitted by the lighting means 24, preferably LEDs 26, from shining through the covering fabric 12.

It is also possible, as a further variant, to provide for an upholstery felt to be inserted between the perimeter frame 8 and the covering fabric 12, to give consistency and softness to the final result.

As may be seen from that which has been described above, the fabric panel illuminated with optical fiber according to the invention allows the disadvantages presented in the known art to be overcome.

In effect, the architecture of the perimeter frame, comprising a first and a second support element, allows one, at the same time, to ensure both an excellent thermal and electrical insulation of the fabric from the lighting means and from the respective power supply means, and an easy assembly and disassembly of the covering fabric from the same frame.

More specifically, the first support element ensures a good thermal dispersion of the heat produced by the lighting means in order to avoid overheating and possible damage to the covering fabric.

Moreover, the first support element is an easy system for attaching the covering fabric to the perimeter frame: in this way, the panel may be quickly disassembled and reassembled without damaging the fabric in any way. In addition, the connection means are arranged in a position hidden to an outside observer.

The positioning of power supply and/or lighting means on the inner side wall of the first support element makes it possible to recover the space or internal volume of the frame that would otherwise be lost, without increasing the overall dimensions, i.e. the overall depth of the panel.

In this way the panel will be easy to use for covering walls, ceilings, furnishing elements and so on.

The second support element acts as a separator element between the covering fabric and the first support element. This prevents direct contact between the covering fabric and the first support element and thus any possible thermal damage to the covering fabric. The second support element helps to strengthen the panel and also allows an adequate stretching or tensioning of the covering fabric on the panel.

Moreover, it is also possible to remove the second support element from the first support element in order to change the overall size and/or shape of the panel using the same first support element that supports the lighting and power supply means.

In this way, one may replace only the covering fabric, for example for design reasons, without having to dismantle the first support element to which both the lighting and the power supply means are preferably attached.

A person skilled in the art, in the object of satisfying contingent and specific requirements, may make numerous modifications and variations to the panels described above, all of which are within the scope of the invention as defined by the following claims.

1. Fabric panel illuminated with optical fiber comprising
a perimeter frame,
a covering fabric, applied frontally to the perimeter frame and covering the latter, said covering fabric comprising in the weft and/or warp a plurality of optical fibers interwoven with textile fibers,
lighting means electrically connected to power supply means and operatively connected to said optical fibers so as to convey in them beams of light,
wherein
the perimeter frame comprises a first support element, whereon the lighting means are fixed, and a second support element, interposed between the covering fabric and the first support element, whereon the covering fabric is fixed.

2. Fabric panel illuminated with optical fiber according to claim 1, wherein the first support element is a metallic element whereon the power supply means of the lighting means are fixed, said metallic element acting as a heat sink.

3. Fabric panel illuminated with optical fiber according to claim 1, wherein said first support element is an aluminum element.

4. Fabric panel illuminated with optical fiber according to claim 1, wherein the power supply means and/or lighting means are detachably fixed to the first support element by removable connection means.

5. Fabric panel illuminated with optical fiber according to claim 4, wherein said removable connection means comprise screws and/or bolts.

6. Fabric panel illuminated with optical fiber according to claim 1, wherein the power supply means and/or lighting means are fixed to an inner side wall of the first support element.

7. Fabric panel illuminated with optical fiber according to claim 1, wherein the second support element is an insulating element thermally and electrically separating the covering fabric from the first support element.

8. Fabric panel illuminated with optical fiber according to claim 1, wherein the second support element is made of wood and/or plastic material.

9. Fabric panel illuminated with optical fiber according to claim 1, wherein the second support element is contoured relative to the first support element so as to follow the perimeter profile.

10. Fabric panel illuminated with optical fiber according to claim 1, wherein the optical fibers of the covering fabric are grouped in bundles, each bundle being turned back at the rear of the panel, on the side opposite to the covering fabric, and fixed to a corresponding lighting means on the first support element.

11. Fabric panel illuminated with optical fiber according to claim 1, wherein a plurality of lighting means electrically connected in series with each other and powered by a single power supply means are fixed to said first support element.

12. Fabric panel illuminated with optical fiber according to claim 1, wherein said lighting means comprise light emitting diodes.

13. Fabric panel illuminated with optical fiber according to claim 1, wherein between the perimeter frame and the covering fabric a blackout fabric layer is installed in order to prevent the light emitted by the lighting means from showing through the covering fabric.

14. Fabric panel illuminated with optical fiber according to claim 1, wherein between the perimeter frame and the covering fabric upholstery felt is placed.
